(19) United States
(12) Patent Application Publication
(10) Pub. No.: US 2012/0297882 A1
(43) Pub. Date: Nov. 29, 2012

(54) APPARATUS FOR PIPELINE INSPECTION

(76) Inventors: Robert Palma, Stutensee (DE); Willliam Herron, Ashington (GB)

(21) Appl. No.: 13/475,338

(22) Filed: May 18, 2012

(30) Foreign Application Priority Data
May 26, 2011 (EP) 11167740.7

(51) Int. Cl. G01N 29/04

(52) U.S. Cl. 73/622

(57) ABSTRACT

An apparatus for pipeline inspection includes a body including a longitudinal axis and a sensor unit in association with the body. The sensor unit has an array of ultrasonic sensors configured to inspect a pipe wall. The sensor unit includes a skid having an outer surface intended to run adjacent or in contact with a pipe wall. The sensor unit also includes a recess, wherein the sensors are arranged in the recess at a predetermined stand off from the outer surface of the skid. The sensor unit also includes a flushing system configured to direct pipeline fluid through the recess to flush debris from the recess when the outer surface of the skid is in contact with a pipe wall.

### BACKGROUND OF THE INVENTION

1. Field of the Invention

The present disclosure relates to pipeline inspection and, more particularly, to a pipeline inspection apparatus.

2. Description of Related Art

It is known to carry out inspection of a pipeline using an apparatus (commonly referred to as a pipeline “pig”), which travels inside the pipeline to measure or detect defects in the wall of the pipeline.

Such an apparatus may include an array of ultrasonic sensors for measuring the wall thickness of the pipeline and/or for detecting cracks in the wall of a pipeline. Typically, the ultrasonic sensors are mounted on a skid, which is designed to run adjacent or in contact with a pipe wall, for example, as a pig carries out an inspection run through a pipeline. The sensors are arranged at a stand off from the outer surface of the skid, in order to protect the sensors against wear or other damage from contact with the pipe wall.

A problem arises if debris from within the pipeline collects over the inspection surface of the ultrasonic sensors, for example, within the stand off region. Hence, it is know for skids to include a flushing system for directing a flow of pipeline fluid over the inspection surface of the sensors, in order to flush away debris as the apparatus travels along the pipeline. However, conventional flushing systems typically consist of retro-fit installations to existing skids, the installation and maintenance of which is not straight forward. Moreover, conventional flushing systems operate with variable results.

### BRIEF DESCRIPTION OF THE INVENTION

The disclosure provides an apparatus for pipeline inspection, the apparatus comprising a body having a longitudinal axis and a sensor unit in association with the body. The sensor unit includes an array of ultrasonic sensors configured to inspect a pipe wall, and a skid having an outer surface intended to run adjacent or in contact with a pipe wall. The sensor unit also includes a recess, wherein the sensors are arranged in the recess at a predetermined stand off from the outer surface of the skid. The sensor unit also includes a flushing system configured to direct pipeline fluid through the recess to flush debris from the recess when the outer surface of the skid is in contact with a pipe wall.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic perspective view of a vessel forming part of an apparatus for pipeline inspection according to an embodiment of the present invention;

FIG. 2 is a schematic perspective view of a sensor unit and carrier for use in the embodiment of FIG. 1;

FIG. 3 is a schematic perspective view of the carrier in FIGS. 1 and 2;

FIG. 4 is a schematic perspective view of a vessel similar to the vessel in FIG. 1, but including multiple sensor units;

FIG. 5 is a schematic diagram showing a vessel of the kind shown in FIG. 4 operable through a pipeline having multiple bore diameters;

FIG. 6 is a schematic perspective view from the upper side of an alternative sensor holder for use on the apparatus of FIG. 1;

FIG. 7 is a schematic perspective view from the underside of the sensor holder in FIG. 6; and

FIG. 8 is a schematic perspective view of a flushing collector for use with the sensor holder of FIGS. 6 and 7.

### DETAILED DESCRIPTION OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims.

Reference throughout the disclosure to “an exemplary embodiment,” “an embodiment,” or variations thereof means that a particular feature, structure, or characteristic described in connection with an embodiment is included in at least one embodiment of the subject matter disclosed. Thus, the appearance of the phrases “in an exemplary embodiment,” “in an embodiment,” or variations thereof in various places throughout the disclosure is not necessarily referring to the same embodiment. Further, the particular features, structures or characteristics may be combined in any suitable manner in one or more embodiments.

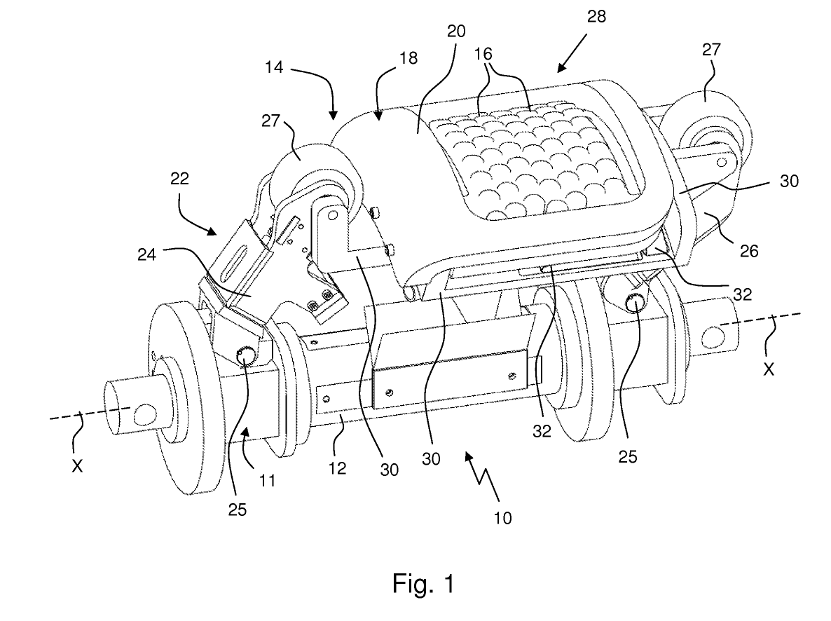

FIG. 1 illustrates part of a pipeline inspection apparatus for in-line inspection of pipelines and is indicated generally at 10. Apparatus 10 includes a vessel 11 having a central body 12 and a longitudinal axis X (extending left to right as viewed in FIG. 1). A sensor unit 14 is mounted on said body 12. The sensor unit 14 includes an array of ultrasonic sensors 16 for inspecting a pipe wall.

The sensor unit 14 includes a skid 18 having an outer surface 20 intended to run adjacent or in contact with a pipe wall, in use. The outer surface 20 is arcuate in a circumferential direction with respect to the longitudinal axis X. The sensors 16 also define an arcuate inspection plane in a circumferential direction with respect to the longitudinal axis X.

The upper surface of the sensors is arranged at a stand off from the outer surface of the skid 18 (for example. radially inward of the outer surface 20), for protecting the sensors 16 against wear or other damage from contact with the pipe wall. The ultrasonic sensors 16 within the inspection array can be orientated normally to the pipe wall for wall thickness evaluation or at an angle to the pipe wall so as to induce shear waves and identify any cracks in the pipeline, for example.

The apparatus 10 includes a spring-loaded mechanism 22 for permitting movement of the sensor unit 14 with respect to the longitudinal axis of the central body 12, for example in response to changes in bore diameter.

The mechanism 22 is configured for biasing the sensor unit 14 in a generally radial direction, in order to bias the outer surface 20 of the skid 18 in the direction of a pipe wall. More particularly, the mechanism 22 is configured for moving the sensor unit 14 between a first radial position (for example, a retracted position for use in a small diameter bore) and a second radial position (for example, an extended position for use in a large diameter bore), in response to changes in pipe diameter. The mechanism 22 is configured to position the sensor unit 14 at an appropriate radial position (for example, intermediate said first and second radial positions), depending on the size of the bore through which the apparatus 10 is passing. Hence, the apparatus 10 can be used for inspection of multi-diameter pipelines or across a range of pipelines having different diameters.

The mechanism 22 includes first and second suspension members 24, 26 configured for biasing the sensor unit 14 in the direction of a pipe wall (for example, in a radial or outward direction relative to the longitudinal axis X). The first and second suspension members 24, 26 are axially off set from one another, with respect to the longitudinal axis of the central body 12.

The first and second suspension members 24, 26 are connected to body 12 by a spring-biased pivotal connection 25, so as to be configured to pivot relative to said longitudinal axis of the central body 12. The suspension members 24, 26 are biased towards said second radial position (i.e. an extended position relative to the body 12). Hence, the suspension members 24, 26 act as spring-biased struts or arms which are movable relative to the central body 12 of the vessel 11, for positioning the sensor unit 14 adjacent the pipe wall. A roller 27 is provided at the end of each suspension member 24, 26, for rolling contact with the internal surface of a pipe along which the apparatus is travelling, in use.

The first and second suspension members 24, 26 form part of a linkage 28, which is configured for movement of the sensor unit 14 radially with respect to the longitudinal axis of the central body 12, for example, between the first radial position and second radial position, in response to changes in bore diameter as the suspension rollers 27 react against the pipe wall.

The linkage 28 includes a carrier 30 arranged for movement with said first and second suspension members 24, 26. The sensor unit 14 is mounted on said carrier 30. The carrier 30 is mounted between the first and second suspension members 24, 26, and the carrier 30 is arranged to remain parallel with the longitudinal axis of the central body 12 during movement of the sensor unit 14.

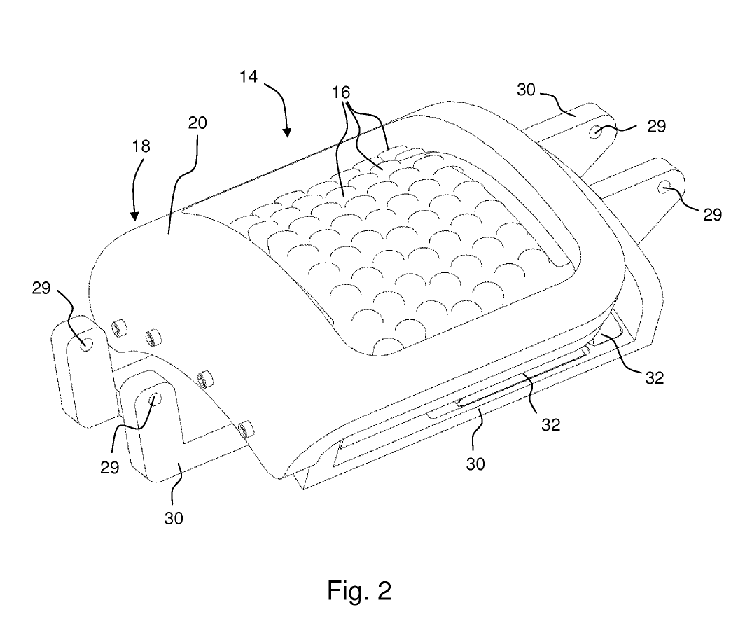

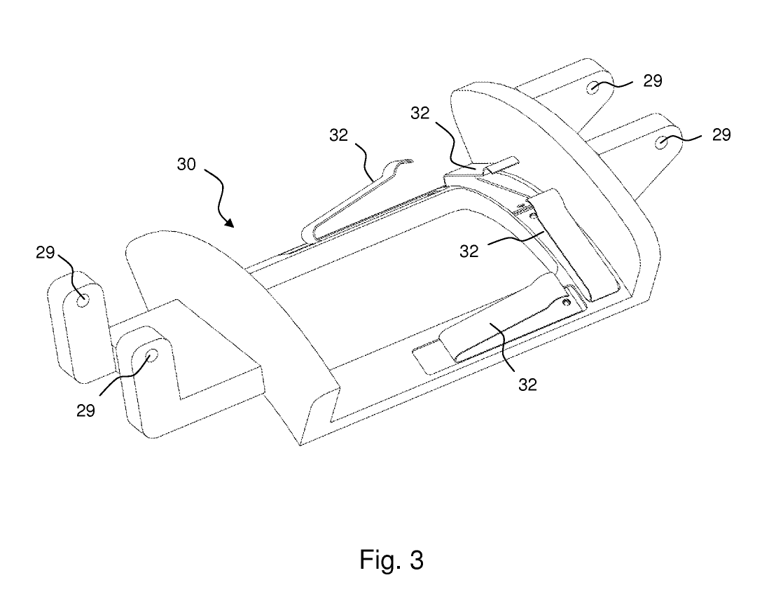

As can be seen clearly in FIGS. 2 and 3, the carrier 30 includes pivot points 29 for connection to the first and second suspension members 24, 26. As can be seen most clearly in FIG. 3, the carrier 30 biasing elements in the form of leaf springs 32, which are arranged beneath the sensor unit 14. The biasing elements provide local biasing of the sensor unit 14 relative to the longitudinal axis of the central body 12, for example, in the direction of the pipe wall. The spring-loaded mechanism 22 ensures that the sensors 16 are deployed adjacent the pipe wall, even in bends (where conventional systems fail or are highly unreliable). Moreover, the localised biasing of the sensor unit 14 on the carrier 30 assists in providing correct orientation and clamping force of the skid 18 against the pipe wall.

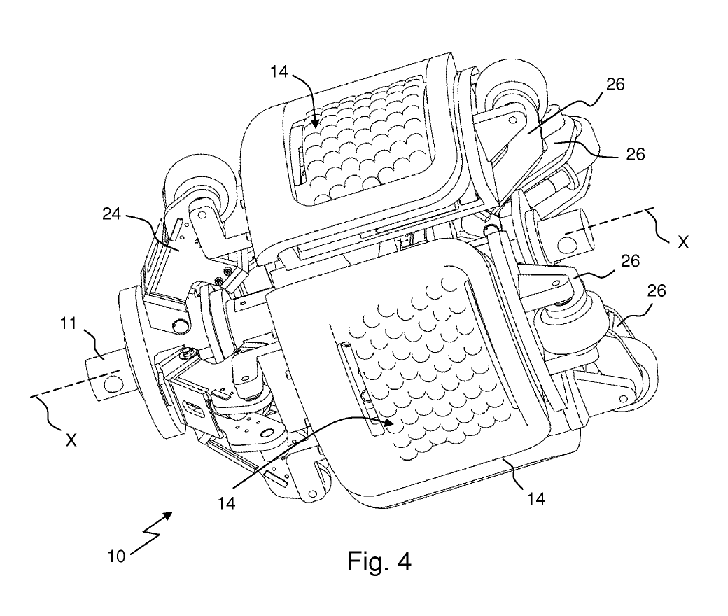

As shown in FIG. 4, the vessel 11 may be provided with multiple sensor units 14, each of which is movably mounted on said central body 12 in the manner described above. In the exemplary embodiment of FIG. 4, the vessel 11 includes four sensor units (only 3 of which are visible as viewed in FIG. 4) arranged at 90 degrees to one another in a ring about the longitudinal axis X.

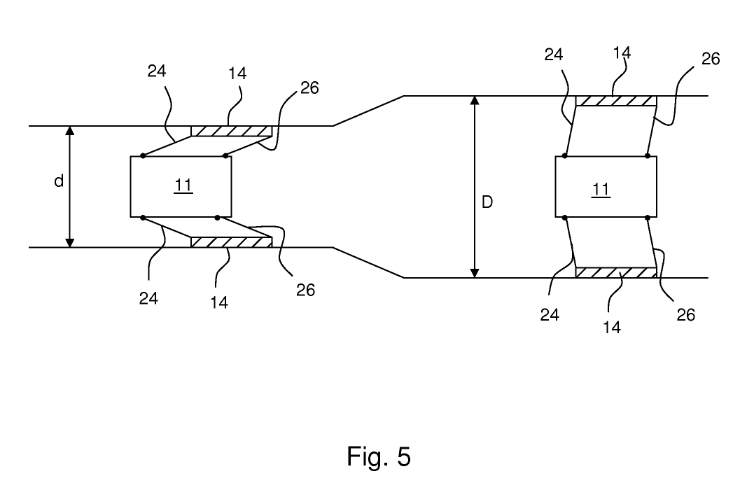

The apparatus 10 is suited for use inspecting a pipeline having a first section with a first bore diameter and a second section with a second bore diameter (i.e. less than or greater than the first bore diameter). The apparatus 10 can be sent on a continuous run through said first and second sections of the pipeline. The mechanism 22 is used to bias the sensor unit 14 against an inner surface of the first section and to automatically bias the sensor unit 14 against an inner surface of the second section upon a change in bore diameter between said first and second sections of the pipeline. An example is shown in FIG. 5.

The apparatus 10 permits accurate modelling of the biasing forces required to maintain the skid 18 in contact with the pipe wall, providing a significant improvement over conventional skid designs. The apparatus 10 is advantageous, at least insofar as it should reduce the time required to design a skid for a given diameter of pipe, by allowing the required forces to be calculated in an early stage in the design procedure, reducing or obviating the need for optimisation loops and other acts of trial and error. Moreover, the linkage 28 permits use of the apparatus across a range of pipeline diameters, including improved tracking of the pipe bore, especially in bends and through restrictive pipeline features such as tapers, valves, etc.

Each linkage 28 can move independently with respect to the other linkages 28 on the vessel 11. This enables the apparatus to pass through and inspect tight bend diameters and difficult or restrictive pipeline features such as tapers, valves, etc. It is envisaged that exemplary embodiments will be cable of inspection through 1D bends and mitre bends.

In the exemplary embodiment of FIG. 1, the linkage 28 takes the form of a 4-bar linkage, consisting of the body 12, suspension members 24, 26 and carrier 30. Other forms of collapsible linkage may be applicable, for example, a 5-bar linkage including said suspension members 24, 26, configured to ensure that the sensor unit 14 tracks the pipe wall irrespective of the attitude of the internal pig body 12 within the pipeline.

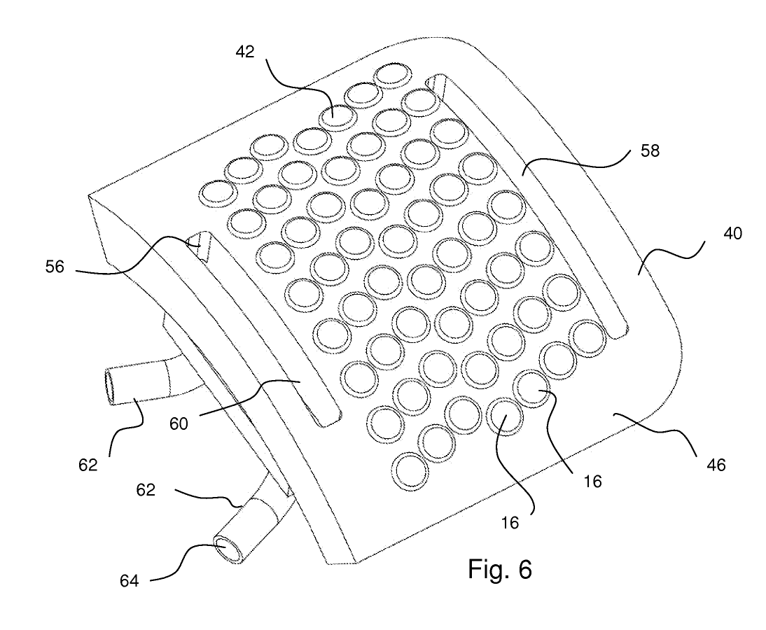

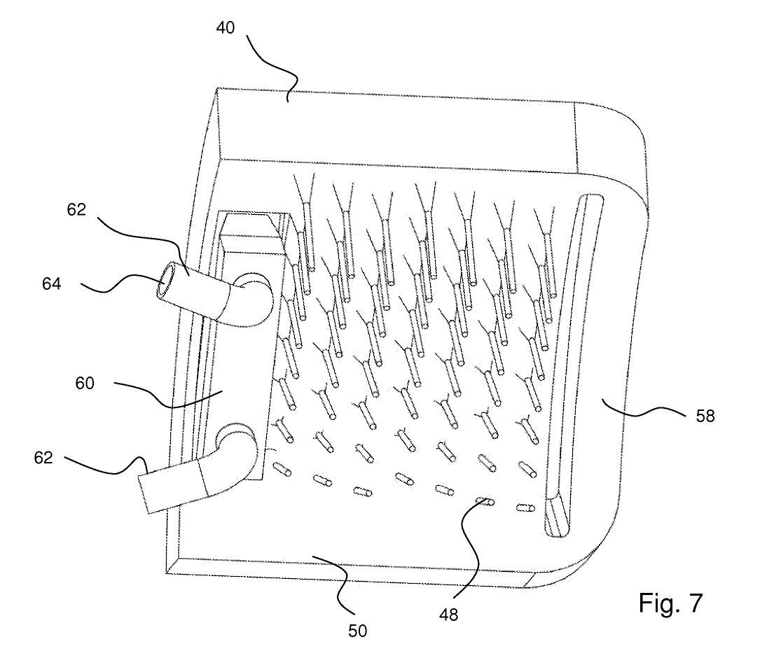

In the illustrated embodiment, the ultrasonic sensors 16 are held in a tight array of rows and columns on a sensor holder 40. As can be seen clearly from FIGS. 6 and 7, the sensors 40 are sealingly embedded within the sensor holder 40. Each sensor 16 has an upper surface 42 which projects from the upper surface 46 sensor holder 40 by a predetermined amount. Each sensor 16 has an output end 48 which projects from an underside 50 of the sensor holder 40.

The upper surfaces 42 of the sensors 16 define an arcuate inspection plane intended to extend in a circumferential direction with respect to the longitudinal axis X of the vessel 11 on which the sensor holder 40 is mounted.

As can be seen from FIG. 1, the upper surfaces 42 of the sensors 16 are arranged at a predetermined distance from the outer surface 20 of the skid 18. In effect, the sensors 16 are arranged in a recess 65 on the sensor unit 14, for example, defined by the skid 18 and an upper surface 46 of the sensor holder 40. The recess 65 is enclosed when the skid 18 is pushed up against a pipe wall.

The sensor unit 14 includes a flushing system for flushing debris from the recess, including a flushing inlet 52 for pipeline fluid to enter the recess 65 and a flushing outlet 54 for pipeline fluid to flow out of the recess 65 when the skid is pushed up against a pipe wall. The flushing outlet 54 is spaced downstream from said flushing inlet 52. Moreover, the flushing inlet 52 is upstream of the sensors 16 and the flushing outlet is downstream of the sensors 16.

The flushing inlet 52 and flushing outlet 54 each consist of a flushing passageway 56 which extends through the sensor holder 40 (for example, from the upper side 46 to the underside 50). In the illustrated embodiment, the flushing inlet 52 and flushing outlet 54 are of elongate form, extending in a generally circumferential direction with respect to the longitudinal axis X of the vessel 11 on which the sensor unit 14 is mounted.

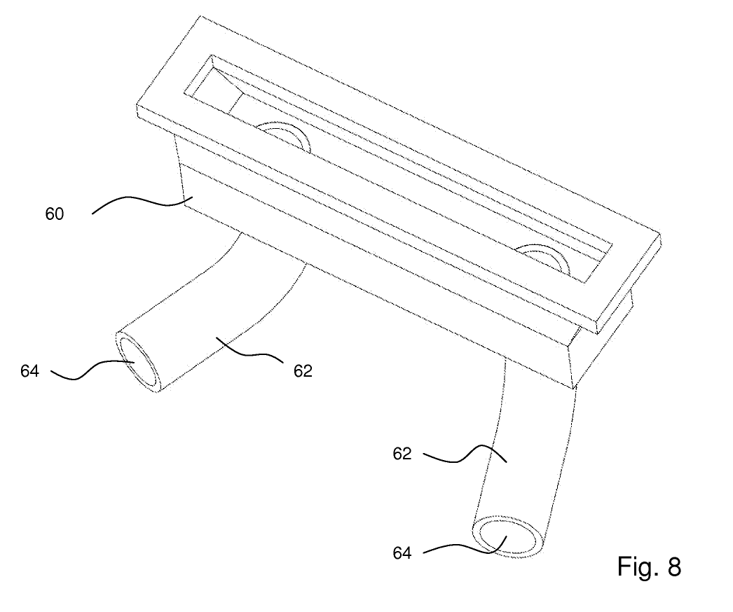

A flushing collector 58, for example, of the kind shown in FIG. 8, may be fitted in or form part of the flushing inlet 52. The flushing collector 58 includes guide pipes 60 (one of which is viewable in FIG. 1), which extend beneath the sensor holder 40 and have an inlet facing in an upstream direction. The guide pipes are configured for channelling fluid from within the pipeline into the recess 65 via the flushing inlet 52.

If the outer surface 20 of the skid 18 is biased against the internal surface of a pipe along which the apparatus 10 is travelling, fluid entering said recess 65 from said flushing inlet 52 will flow over the top of the sensors 16, across the upper surface 46 of the sensor holder 40, and down through the flushing outlet 54. The flow of fluid in this manner is intended to dislodge and carry away debris and the like which may have collected, or which might otherwise attempt to collect, on the holder 40.

The flushing collector 58 of the kind shown in FIG. 8 is easy to install, and the provision of a biasing mechanism 22 and/or local biasing of the skid 18 against the pipe wall provides a particularly effective flushing system.

Although FIG. 1 is described with spring-loaded suspension members in the form of pivotable arms or struts, other types of suspension may be employed. Although FIG. 3 is described with leaf springs for local biasing of the sensor unit on the carrier, other forms of resilient biasing element may be incorporated. Although FIG. 4 shows an embodiment having a ring of four sensor units, other embodiments may consist of three or more sensor units per ring. Multiple rings of sensor units may be included per vessel 11.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended and are understood to be within the scope of the claims.

What is claimed is:

1. An apparatus for pipeline inspection, the apparatus comprising:
a body comprising a longitudinal axis and a sensor unit in association with the body, the sensor unit comprising: an array of ultrasonic sensors configured to inspect a pipe wall;
a skid comprising an outer surface intended to run adjacent or in contact with a pipe wall;
a recess, wherein the sensors are arranged in the recess at a predetermined stand off from the outer surface of the skid; and a flushing system configured to direct pipeline fluid through the recess to flush debris from the recess when the outer surface of the skid is in contact with a pipe wall.

2. The apparatus according to claim 1, wherein the outer surface of the skid defines a periphery of the recess and the recess is arranged to be enclosed by a pipe wall when the periphery of the recess is in contact with a pipe wall.

3. The apparatus according to claim 1, wherein the sensors are sealingly mounted on a sensor holder, and wherein an upper surface of the sensor holder defines a wall of the recess for the passage of flushing fluid over the upper surface.

4. The apparatus according to claim 3, wherein the sensor holder further comprises a flushing inlet for pipeline fluid to enter the recess.

5. The apparatus according to claim 4, further comprising a flushing outlet spaced downstream from the flushing inlet for pipeline fluid to flow out of the recess.

6. The apparatus according to claim 5, wherein the flushing outlet is formed in the sensor holder.

7. The apparatus according to claim 1, wherein the flushing system comprises a flushing collector having one or more guides with an inlet facing in an upstream direction and configured to channel fluid from within the pipeline into the recess.

8. The apparatus according to claim 1, comprising a plurality of sensor units arranged in a circumferentially spaced array, wherein the sensor units are arranged for movement between a first radial position and a second radial position in response to changes in pipe diameter, and are biased towards an extended position configured to bias the outer surface of the skid into contact with a pipe wall in the first and second radial positions.

9. The apparatus according to claim 1, further comprising a mechanism configured to bias the outer surface of the skid into contact with a pipe wall.

10. The apparatus according to claim 9, wherein the mechanism is configured to permit movement of the sensor unit between a first position and a second position relative to the longitudinal axis in response to changes in pipe diameter.

11. The apparatus according to claim 10, wherein the mechanism comprises at least one arm or strut configured to deploy the sensor unit adjacent a pipe wall.

12. The apparatus according to claim 9, wherein the mechanism comprises first and second suspension members axially off set from one another with respect to the longitudinal axis of the body, and configured to pivot relative to the longitudinal axis of the body.

13. The apparatus according to claim 9, wherein the mechanism defines a collapsible linkage arranged to permit inward movement of the sensor unit with respect to the longitudinal axis of the body in response to a decrease in pipe diameter.

14. The apparatus according to claim 13, wherein the linkage comprises a carrier for the sensor unit, wherein the linkage is configured to bias the carrier in the direction of a pipe wall through changes in pipe diameter.

15. The apparatus according to claim 14, wherein the sensor unit is mounted on the carrier and is locally biased in an outward direction on the carrier.
